(19) United States
(12) Patent Application Publication
(10) Pub. No.: US 2003/0169539 A1
(43) Pub. Date: Sep. 11, 2003

(54) Electrostatic discharge insensilive recording head with a high-resistance gap layer

(75) Inventor: Howard G. Zolla, Santa Clara, CA (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/093,260

(22) Filed: Mar. 7, 2002

(51) Int. Cl. G11B 5/39

(52) U.S. Cl. 360/323; 360/320

(57) ABSTRACT

The invention provides a magnetoresistive read head comprising a bottom shield and a top shield. The bottom shield and the top shield are spaced apart to form a read gap. A magnetoresistive sensor and a resistive layer are disposed within the read gap whereby any electric charge developed across the read gap layer is dissipated to thereby prevent any electrostatic discharge damage to the magnetoresistive read head. The resistive layer is preferably made from a cermet family of films.

### FIELD OF THE INVENTION

In general, the present invention relates to a magnetoresistive (“MR”) read head incorporated with devices (e.g., a magnetic disk drive and a magnetic tape drive) employing the MR read head to read data from a magnetic data storage medium (e.g., a platter or a magnetic tape). More specifically, the present invention relates to a prevention of electrostatic discharge (ESD) damage to the MR read head during fabrication and operation of the MR read head.

### BACKGROUND OF THE INVENTION

In FIG. 1, a MR read head 10 as known in the art is shown. A read gap 13 is established between a bottom shield 11 and a top shield 12. Within the read gap 13 is a conventional formation of a MR sensor 14, a pair of bias layers BL 15a and BL 15b, and a pair of leads 16a and 16b as well as a bottom insulation layer 17 and a top insulation layer 18. The bottom insulation layer 17 is deposited on the bottom shield 11. The MR sensor 14, the pair of bias layers 15a and 15b, and the pair of leads 16a and 16b are deposited on the bottom insulation layer 17. The top insulation layer 17 is deposited on the MR sensor 14, the pair of bias layers 15a and 15b, and the pair of leads 16a and 16b. The top shield 12 is deposited on the top insulation layer 17.

Current advances in the MR thin film technology are directed toward increasing the areal density performance of the MR sensor 14 within the MR read head 10. However, the bottom shield 11 and the MR sensor 14 have a mutual capacitance, and the top shield 12 and the MR sensor 14 have a mutual capacitance. Consequently, an electric charge resulting from fabrication and/or operation of the MR read head 10 can develop on the bottom shield 11 and the MR sensor 14 to form an electric field across the bottom insulation layer 17. Additionally, an electric charge resulting from fabrication and/or operation of the MR read head 10 can develop on the top shield 12 and the MR sensor 14 to form an electric field across the top insulation layer 18. The intensity of these electric fields can eventually reach a breakdown point that results in a low-resistance short across the bottom insulation layer 17 and/or the top insulation layer 18 that renders MR read head 10 inoperable. As such, any benefits from advancements in the areal density performance of MR read head 10 are not realized.

Thus, there is a significant need for a novel structure of a MR read head whereby the benefits of advancements in areal density performance of the MR read head can be realized.

### SUMMARY OF THE INVENTION

One aspect of the invention provides a MR read head comprising a bottom shield and a top shield spaced from the bottom shield to form a read gap. The MR read head further comprises a MR sensor and a resistive layer disposed within the read gap.

Another aspect of the invention provides a magnetic storage device comprising a magnetic data storage medium having data, and a MR read head operable to read the data. The MR read head comprises a bottom shield and a top shield spaced from the bottom shield to form a read gap. The MR read head further comprises a MR sensor and a resistive layer disposed within the read gap.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagrammatic view illustrating a magnetoresistive read head as known in the art;

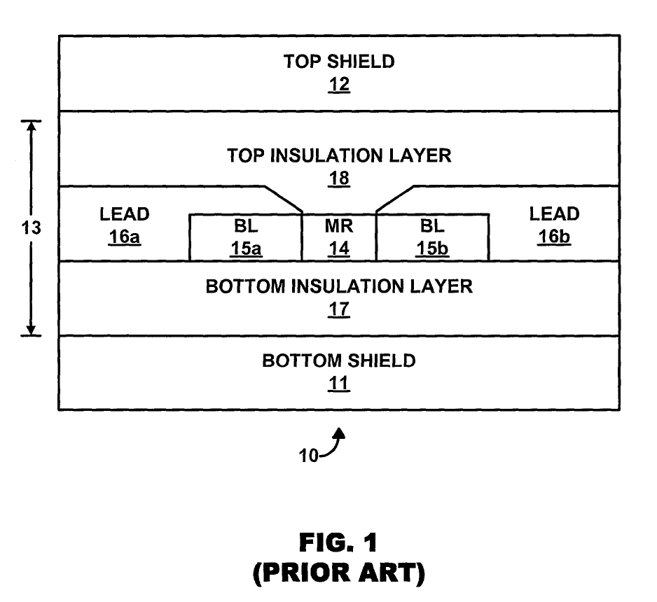

FIG. 2 is a diagrammatic view illustrating a first embodiment of a magnetoresistive read head in accordance with the present invention;

FIG. 3 is a diagrammatic view illustrating a second embodiment of a magnetoresistive read head in accordance with the present invention;

FIG. 4 is a diagrammatic view illustrating a third embodiment of a magnetoresistive read head in accordance with the present invention; and

FIG. 5 is top view illustrating one embodiment of a magnetic storage device in accordance with the present invention.

### DETAILED DESCRIPTION OF THE PRESENTLY PREFERRED EMBODIMENTS

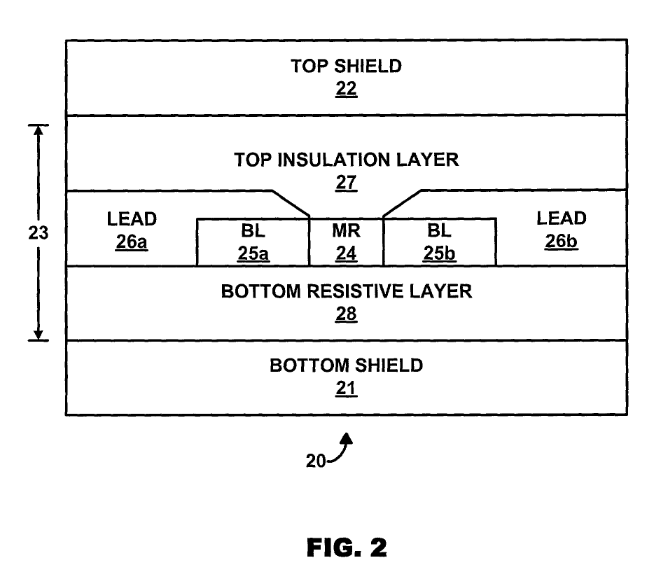

In FIG. 2, a MR read head 20 of the present invention as fabricated by one of many known techniques is shown. A read gap 23 is established between a bottom shield 21 and a top shield 22. Within the read gap 23 is a conventional formation of a MR sensor 24, a pair of bias layers (“BL”) 25a and (“BL”} 25b, and a pair of leads 26a and 26b as well as a top insulation layer 27 and a bottom resistive layer 28. The MR sensor 24 can be in one of many forms as would occur to those having ordinary skill in the art, such as, for example, a giant magnetoresistive sensor or a tunnel magnetoresistive sensor. The bias layers 25a and 25b can be in one of many forms as would occur to those having ordinary skill in the art, such as, for example, hard bias layers or exchange bias layers.

The bottom resistive layer 28 is deposited on the bottom shield 21. The MR sensor 24, the pair of bias layers 25a and 25b, and the pair of leads 26a and 26b are deposited on the bottom resistive layer 28. The top insulation layer 27 is deposited on the MR sensor 24, the pair of bias layers 25a and 25b, and the pair of leads 26a and 26b. The top shield 22 is deposited on the top insulation layer 27.

Preferably, the bottom resistive layer 28 is formed from a Cermet family of films including chromium-silicon0-oxygen (Cr—SiO), nickel-chromimum-oxygen (NiCrO), nickel-zirconium-oxygen (Ni—ZrO2), platinum-titanium-oxygen (Pt—TiO2), and titanium-chromium-aluminum-oxygen (Ti—Cr—Al—O). The dimensions of the bottom resistive layer 28 are derived to obtain an isolation resistance of the bottom resistive layer 28 that dissipates any electric field developed between MR sensor 24 and the bottom shield 21 to thereby prevent any ESD damage to the MR read head 20 during fabrication and operation. The dimensions of the bottom resistive layer 28 are dependent upon many variables that outside the scope of the invention. However, those having ordinary skill in the art will appreciate such variables and will be able to derive the dimensions of the bottom resistive layer 28 to obtain an appropriate isolation resistance as described herein.

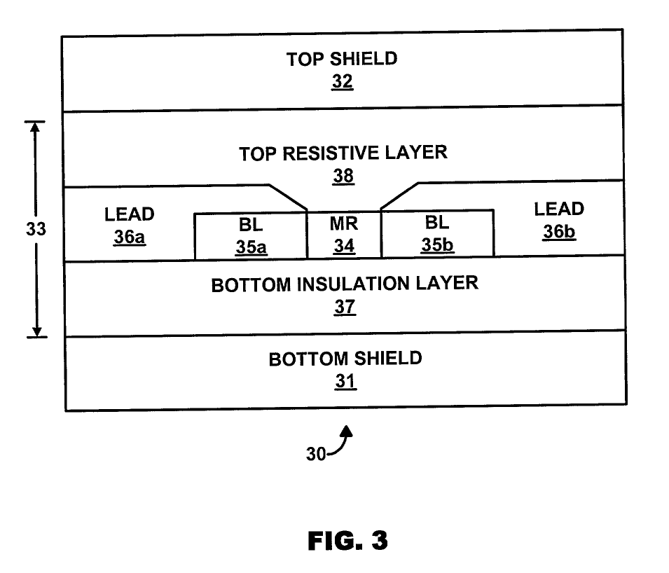

In FIG. 3, a MR read head 30 of the present invention as fabricated by one of many known techniques is shown. A read gap 33 is established between a bottom shield 31 and a top shield 32. Within the read gap 33 is a conventional formation of a MR sensor 34, a pair of bias layers (“BL”) 35a and (“BL”) 35b, and a pair of leads 36a and 36b as well as a bottom insulation layer 37 and a top resistive layer 38. The MR sensor 34 can be in one of many forms as would occur to those having ordinary skill in the art, such as, for example, a giant magnetoresistive sensor or a tunnel magnetoresistive sensor. The bias layers 35a and 35b can be in one of many forms as would occur to those having ordinary skill in the art, such as, for example, hard bias layers or exchange bias layers.

The bottom insulation layer 37 is deposited on the bottom shield 31. The MR sensor 34, the pair of bias layers 35a and 35b, and the pair of leads 36a and 36b are deposited on the bottom insulation layer 37. The top resistive layer 38 is deposited on the MR sensor 34, the pair of bias layers 35a and 35b, and the pair of leads 36a and 36b. The top shield 32 is deposited on the top resistive layer 38.

Preferably, the top resistive layer 38 is formed from a Cermet family of films including Cr—SiO, NiCrO, Ni—ZrO3, Pt—TiO3, and Ti—Cr—Al—O. The dimensions of the top resistive layer 38 are derived to obtain an isolation resistance of the top resistive layer 38 that any electric field developed between the MR sensor 34 and the top shield 32 to thereby prevent any ESD damage to the MR read head 30 during fabrication and operation. The dimensions of the top resistive layer 38 are dependent upon many variables that outside the scope of the invention. However, those having ordinary skill in the art will appreciate such variables and will be able to derive the dimensions of the top resistive layer 38 to obtain an appropriate isolation resistance as described herein.

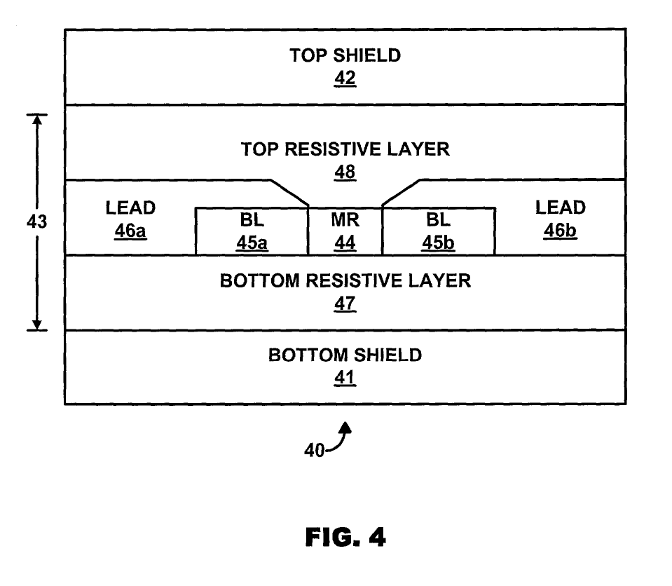

In FIG. 4, a MR read head 40 of the present invention as fabricated by one of many known techniques is shown. A read gap 43 is established between a bottom shield 41 and a top shield 42. Within the read gap 43 is a conventional formation of a MR sensor 44, a pair of bias layers (“BL”) 45a and (“BL”) 45b, and a pair of leads 46a and 46b as well as a bottom resistive layer 47 and a top resistive layer 48. The MR sensor 44 can be in one of many forms as would occur to those having ordinary skill in the art, such as, for example, a giant magnetoresistive sensor or a tunnel magnetoresistive sensor. The bias layers 45a and 45b can be in one of many forms as would occur to those having ordinary skill in the art, such as, for example, hard bias layers or exchange bias layers.

The bottom resistive layer 47 is deposited on the bottom shield 41. The MR sensor 44, the pair of bias layers 45a and 45b, and the pair of leads 46a and 46b are deposited on the bottom resistive layer 47. The top resistive layer 48 is deposited on the MR sensor 44, the pair of bias layers 45a and 45b, and the pair of leads 46a and 46b. The top shield 42 is deposited on the top resistive layer 48.

Preferably, the bottom resistive layer 47 and the top resistive layer 48 are formed from a Cermet family of films including Cr—SiO, NiCrO, Ni—ZrO4, Pt—TiO4, and Ti—Cr—Al—O. The dimensions of the bottom resistive layer 47 are derived to obtain an isolation resistance of the bottom resistive layer 47 that dissipates any electric field developed between the MR sensor 44 and the bottom shield 41 to thereby prevent any ESD damage to the MR read head 40 during fabrication and operation. The dimensions of the top resistive layer 48 are derived to obtain an isolation resistance of the top resistive layer 48 that dissipates any electric field developed between the MR sensor 44 and the top shield 42 to thereby prevent any ESD damage to the MR read head 40 during fabrication and operation. The dimensions of the bottom resistive layer 47 and the top resistive layer 48 are dependent upon many variables that outside the scope of the invention. However, those having ordinary skill in the art will appreciate such variables and will be able to derive the dimensions of the bottom resistive layer 47 and the top resistive layer 48 to obtain appropriate isolation resistances as described herein.

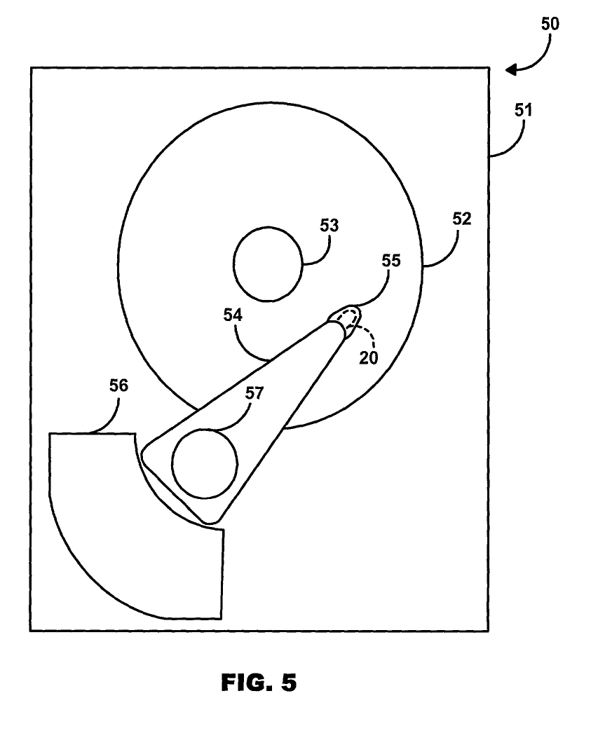

In FIG. 5, a magnetic disk drive 50 is shown. Magnetic disk drive 50 comprises an opened case 51 containing a magnetic data storage medium in the form of a platter 52 mounted on a rotating spindle 53 of a motor (not shown). A slider arm 54 has a proximal end coupled to an actuator axle 57 of an actuator 56. The MR read head 20 (FIG. 2) is mounted on or integrated with a suspension arm 55 on a distal end of slider arm 54 by conventional methods known in the art. The MR read head 20 is positioned adjacent the platter 52 to thereby read data stored on the platter 52 as would occur to those having ordinary skill in the art. Alternatively, the MR read head 30 (FIG. 3), MR read head 40 (FIG. 4), and other MR read heads fabricated under the principles of the present invention can be mounted on or integrated with the suspension arm 55. Additionally, the MR read head 20, the MR read head 30, MR read head 40, and other MR read heads fabricated under the principles can be incorporated in other devices as would occur to those having ordinary skill in the art, such as, for example, a magnetic tape drive. These devices would also employ the MR read head of the present invention to read data from an associated magnetic data storage medium, such as, for example, magnetic tape.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

I claim:

1. A magnetoresistive read head, comprising:
a bottom shield;
a top shield spaced from said bottom shield to form a read gap;
a magnetoresistive sensor disposed within the read gap; and
a first resistive layer disposed within the read gap.

2. The magnetoresistive read head of claim 1, wherein
said first resistive layer is deposited on said bottom shield, and
said magnetoresistive sensor is deposited on said first resistive layer.

3. The magnetoresistive read head of claim 2, further comprising:
an insulation layer deposited on said magnetoresistive sensor,
wherein said top shield is deposited on said insulation layer.

4. The magnetoresistive read head of claim 1, wherein
said first resistive layer is deposited on said magnetoresistive sensor, and
said top shield is deposited on said first resistive layer.

5. The magnetoresistive read head of claim 4, further comprising:
an insulation layer deposited on said bottom shield
wherein said magnetoresistive sensor is deposited on said insulation layer.

6. The magnetoresistive read head of claim 1, further comprising:
a second resistive layer disposed within the read gap.

7. The magnetoresistive read head of claim 6, wherein
said magnetoresistive sensor is deposited on said first resistive layer; and
said second resistive layer is deposited on said magnetoresistive sensor.

8. The magnetoresistive read head of claim 1, wherein said first resistive layer is selected from a group of material from a cermet family of films.

9. The magnetoresistive read head of claim 1, wherein said first resistive layer is selected from a group of material consisting of Cr—SiO, NiCrO, Ni—ZrO2, Pt—TiO2, and Ti—Cr—Al—O.

10. The magnetoresistive read head of claim 1, wherein said magnetoresistive sensor is a giant magnetoresistive sensor.

11. The magnetoresistive read head of claim 1, wherein said magnetoresistive sensor is a tunnel magnetoresistive sensor.

12. A device, comprising:
a magnetic data storage medium operable to store data; and
a magnetoresistive read head operable to read the data, said magnetoresistive read head including
a bottom shield,
a top shield spaced from said bottom shield to form a read gap,
a magnetoresistive sensor disposed within the read gap, and
a first resistive layer disposed within the read gap.

13. The device of claim 12, wherein
said first resistive layer is deposited on said bottom shield, and
said magnetoresistive sensor is deposited on said first resistive layer.

14. The device of claim 13, wherein
said magnetoresistive read head further includes an insulation layer deposited on said magnetoresistive sensor; and
said top shield is deposited on said insulation layer.

15. The device of claim 12, wherein
said first resistive layer is deposited on said magnetoresistive sensor, and
said top shield is deposited on said first resistive layer.

16. The device of claim 15, wherein
said magnetoresistive read head further includes an insulation layer deposited on said bottom shield; and
said magnetoresistive sensor is deposited on said insulation layer.

17. The device of claim 12, further comprising:
a second resistive layer disposed within the read gap.

18. The device of claim 17, wherein
said magnetoresistive sensor is deposited on said first resistive layer; and
said second resistive layer is deposited on said magnetoresistive sensor.

19. The device of claim 11, wherein said first resistive layer is selected from a group of material from a cermet family of films.

20. The device of claim 12, wherein said first resistive layer is selected from a group of material consisting of Cr—SiO, NiCrO, Ni—ZrO2, Pt—TiO2, and Ti—Cr—Al—O.

21. The device of claim 12, wherein said magnetoresistive sensor is a giant magnetoresistive sensor.

22. The device of claim 12, wherein said magnetoresistive sensor is a tunnel magnetoresistive sensor.
